(19) United States
(12) Patent Application Publication
(10) Pub. No.: US 2025/0181867 A1
(43) Pub. Date: Jun. 5, 2025

(54) IMAGE PROCESSING DEVICE AND IMAGE PROCESSING METHOD

(71) Applicant: MIMAKI ENGINEERING CO., LTD., Nagano (JP)

(72) Inventor: Keita Nishio, Nagano (JP)

(73) Assignee: MIMAKI ENGINEERING CO., LTD., Nagano (JP)

(21) Appl. No.: 18/844,985

(22) PCT Filed: Mar. 16, 2023
(86) PCT No.: PCT/JP2023/010229

§ 371 Date: Sep. 9, 2024

(30) Foreign Application Priority Data
Mar. 17, 2022 (JP) 2022-042160

(51) Int. Cl. G06K 15/02

(52) U.S. Cl. CPC G06K 15/1807; G06K 15/1889

(57) ABSTRACT

Provided are an image processing device and an image processing method capable of printing an image on a recording medium without overlapping image regions subjected to different processes. An information processing device is a device for performing printing based on image data on a recording medium using a printing device. In order to print an image of image data by a plurality of different processes, the information processing device divides the image data into a plurality of image regions for each of the different processes, assigns the image regions to a plurality of job layers for each of the different processes, and generates print data by combining the plurality of job layers. The information processing device can assign an image region to a job layer so as not to overlap with an image region of another job layer.

### CROSS-REFERENCE TO RELATED APPLICATION

This application is a 371 application of the International PCT application serial no. PCT/JP2023/010229 filed on Mar. 16, 2023, which claims the priority benefit of Japan Patent Application No. JP 2022-042160 filed on Mar. 17, 2022. The entirety of each of the above-mentioned patent applications is hereby incorporated by reference herein and made a part of this specification.

### BACKGROUND

### Technical Field

The present disclosure relates to an image processing device and an image processing method.

### Background Art

When an image is printed on a recording medium, various processes are performed on image data.

For example, Patent Literature 1 discloses an image processing device that generates intermediate data including color information of each color image data based on color image data, extracts a specific color image data from the intermediate data, and converts the color information of the extracted specific color image data into color information expressed by process colors.

### CITATION LIST

### Patent Literature

Patent Literature 1: Japanese Patent Publication No. 6098995

### SUMMARY OF DISCLOSURE

### Technical Problems

Here, image processing for generating a plurality of job layers may be performed as a process for the image data. One purpose of generating a plurality of job layers is to perform multilayer printing for printing images in an overlapping manner.

Multilayer printing will be described with reference to FIGS. 8 and 9. FIGS. 8(A) and 9(A) are schematic diagrams illustrating job layers used for multilayer printing. FIGS. 8(B) and 9(B) are schematic views illustrating a printing state on a product, that is, a recording medium 100 by multilayer printing, and illustrate a top view and an enlarged cross-sectional views of a cross section taken along line A-A′ in the top view.

In the example of FIG. 8(A) and FIG. 8(B), an image is formed on the recording medium 100 by the job layer L1 and the job layer L2. The job layer L1 indicates the background of the image region indicated by the job layer L2. The images formed by the job layer L1 and the job layer L2 may be the same material or different materials.

The job layer L1 and the job layer L2 are combined to generate print data, and an image is printed on the recording medium 100 in the order of the job layer L1 and the job layer L2. As a result, as illustrated in FIG. 8(B), the image formed in the job layer L2 overlaps the image formed in the job layer L1.

In the example of FIG. 9(A) and FIG. 9(B), the recording medium 100 is a transparent medium. Although the job layers L1 to L3 indicate image regions formed at the same position with respect to the recording medium 100, the job layers L1 to L3 have different colors or images. For example, in the example of the job layers L1 to L3 illustrated in FIG. 9(A) and FIG. 9(B), although the contours of the images are the same, the colors of the images of the job layers L1 to L3 are different from each other, and the job layer L2 is white.

The job layers L1 to L3 are combined to generate print data, and an image is printed on the recording medium 100 in the order of the job layer L1, the job layer L2, and the job layer L3. As a result, as illustrated in FIG. 9(B), the central layer printed on the recording medium 100 becomes a white layer, and the image formed by the job layer L3 is visually recognized from the B direction which is the side on which the image is formed. On the other hand, the image formed by the job layer L1 is visually recognized from the C direction which is the transparent medium side.

In this manner, by overlapping a plurality of job layers and performing printing, an image with a bulge, which is also expressed as 2.5 dimensions may be printed, or by using a transparent medium as the recording medium 100, printing to express different images on both sides of the recording medium 100 can be performed.

However, when the images are printed in an overlapping manner, for example, different colors (color inks) may be mixed and fixed to the recording medium, and it may be not preferable to print the images with the material bulging.

Therefore, an object of the present disclosure is to provide an image processing device and an image processing method capable of printing an image on a recording medium without image regions subjected to different processes overlapping.

### SUMMARY

An image processing device according to one aspect of the present disclosure is an image processing device for performing printing based on image data on a recording medium using a printing device, the image processing device including an image region dividing means configured to divide the image data into a plurality of image regions for each of a plurality of different processes to print an image of the image data by the plurality of different processes; an assigning means configured to assign the image region to a plurality of job layers for each of the different processes; and a print data generation means configured to generate print data by combining the plurality of the job layers; wherein the assigning means assigns the image region to the job layer so as not to overlap the image region of another job layer.

According to the present configuration, a plurality of job layers are generated by dividing an image region for each of the different processes for the image data, and print data is generated by combining the plurality of job layers. The image region assigned to the job layer and the image region assigned to another job layer do not overlap each other. As a result, in this configuration, an image can be printed on the recording medium without the image regions subjected to different processes overlapping each other.

In the image processing device described above, in the job layer, mask process may be performed on a region other than the assigned image region. According to this configuration, images subjected to different processes can be more reliably prevented from overlapping on the recording medium.

In the image processing device described above, a predetermined job layer among a plurality of the job layers may be replaced with a plurality of the job layers generated separately. According to this configuration, the user can set different processes for a desired job layer.

In the image processing device described above, the assigning means may assign the image region overlapping the image region assigned to another job layer to some of the job layers. According to this configuration, the image formed on the recording medium is raised, and an image with high decorativeness can be printed.

An image processing method according to one aspect of the present disclosure is an image processing method for performing printing based on image data on a recording medium using a printing device, the image processing method including a first step of dividing the image data into a plurality of image regions for each of a plurality of different processes to print an image of the image data by the plurality of different processes; a second step of assigning the image region to a plurality of job layers for each of the different processes; and a third step of generating print data by combining a plurality of the job layers; wherein the second step assigns the image region to the job layer so as not to overlap the image region of another job layer.

### Effect of the Disclosure

The present disclosure aims to provide an image processing device and an image processing method capable of printing an image on a recording medium without image regions subjected to different processes overlapping.

### BRIEF DESCRIPTION OF THE DRAWINGS

FIG. 1 is a schematic configuration view of a printing system of the present embodiment.

FIG. 2 is a functional block diagram related to an information processing device and a print control device of the present embodiment.

FIG. 3 is a flowchart illustrating a flow of print data generation process of the present embodiment.

FIG. 4(A) and FIG. 4(B) are schematic diagrams illustrating a job layer and a printing state on a recording medium according to the present embodiment.

FIG. 5(A) and FIG. 5(B) are schematic diagrams illustrating a job layer and a printing state on a recording medium in a case where texture process of the present embodiment is performed.

FIG. 6(A) and FIG. 6(B) are schematic diagrams illustrating a job layer and a printing state on a recording medium in a case where texture process of the present embodiment is performed.

FIG. 7(A) and FIG. 7(B) are schematic diagrams illustrating a job layer and a printing state on a recording medium in a case where overlapping printing of the present embodiment is performed.

FIG. 8(A) and FIG. 8(B) are schematic views illustrating conventional multilayer printing.

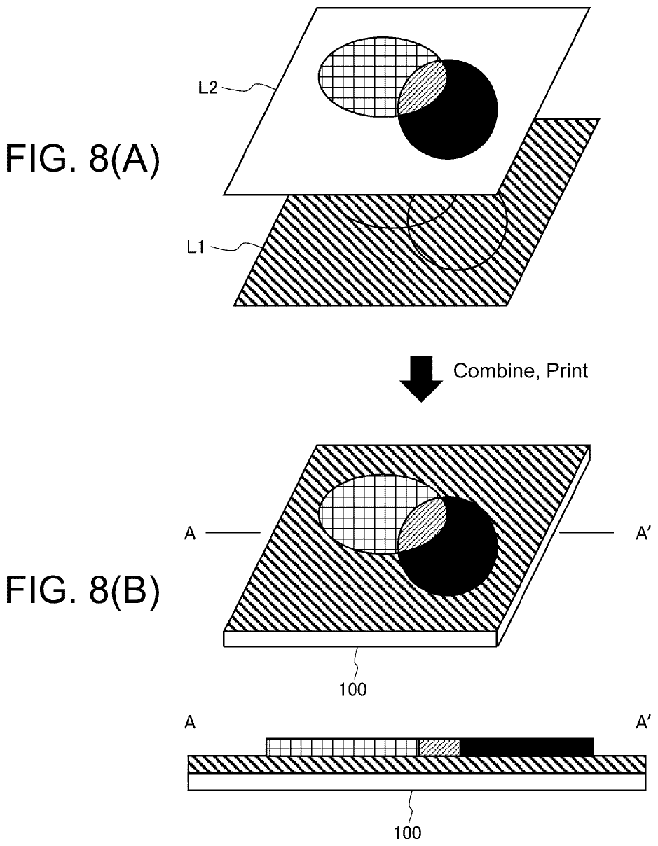

FIG. 9(A) and FIG. 9(B) are schematic views illustrating conventional multilayer printing.

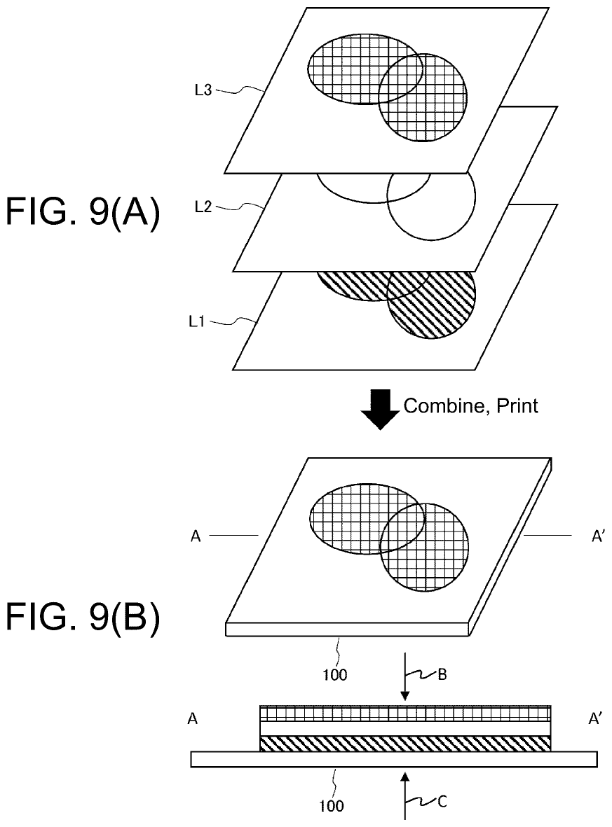

### DESCRIPTION OF EMBODIMENTS

Hereinafter, a printing system 10 according to an embodiment of the present disclosure will be described with reference to the drawings.

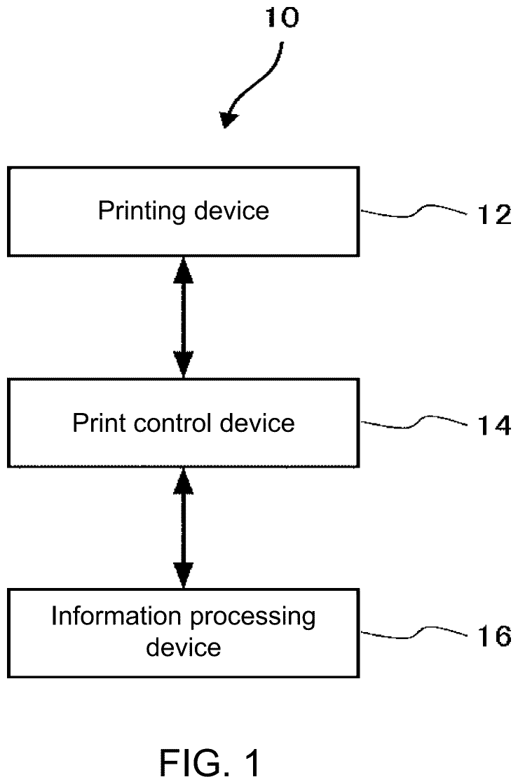

FIG. 1 is a schematic configuration view of a printing system 10 of the present embodiment. The printing system 10 includes a printing device 12, a print control device 14, and an information processing device 16.

The printing device 12 is, for example, an inkjet printer that ejects ink droplets from an inkjet head onto a recording medium to form an image on the recording medium. An inkjet printer ejects process color inks (hereinafter, referred to as “color ink”.) such as yellow, magenta, cyan, and black based on image data and performs printing on the recording medium placed on a platen.

The printing device 12 of the present embodiment may include a foil transfer device so that foil transfer printing can be performed on a recording medium. When foil transfer printing is performed, the printing device 12 ejects an adhesive ink onto a foil transfer region of a recording medium. Then, the foil transfer device transfers the foil to the foil transfer region where the adhesive ink is ejected. Note that the recording medium onto which the color ink and the adhesive ink have been ejected may be appropriately heated before the foil is transferred.

The color ink and the adhesive ink of the present embodiment are solvent inks, but are not limited thereto, and the color ink and the adhesive ink may be ultra violet (UV) inks. Furthermore, the color ink may be a solvent ink, and the adhesive ink may be a UV ink. Moreover, the color ink may be a UV ink, and the adhesive ink may be a solvent ink.

In the present embodiment, as an example, the adhesive ink is treated as a special color, and the color ink and the adhesive ink are ejected from the same inkjet head. Note that when performing printing using inks of different materials, the printing device 12 may include two or more inkjet heads such as an inkjet head that ejects solvent ink and an inkjet head that ejects UV ink.

The print control device 14 controls the printing device 12 to form an image on a recording medium based on the input print data. The print control device 14 includes a central processing unit (CPU), a random access memory (RAM), a read only memory (ROM), a computer-readable storage medium, and the like.

The information processing device 16 is a computer operated by a user, and includes, for example, a monitor, a CPU, a RAM, a ROM, a computer-readable storage medium, and the like. The information processing device 16 according to the present embodiment functions as an image processing device that generates image data indicating an image to be printed on a recording medium and performs various types of processing on the image data. Furthermore, the information processing device 16 generates print data based on the image data after the image processing and transmits the print data to the print control device 14.

The information processing device 16 according to the present embodiment performs print data generation process of generating a plurality of job layers by dividing an image region for each different process (job) of printing an image of image data, and generating print data by combining the plurality of job layers. In the print data generation process of the present embodiment, the image region is assigned to the job layer so that the image region of the job layer does not overlap the image region of another job layer. As a result, the printing system 10 can print an image on the recording medium without overlapping image regions subjected to different process.

The different process is printing using different materials and methods. The different materials are, for example, different colors, different coloring materials (dye and pigment, color ink and adhesive ink, or solvent ink and UV ink), and the like. Furthermore, different methods are different data conversion process for the image region, printing by different inkjet heads, and the like.

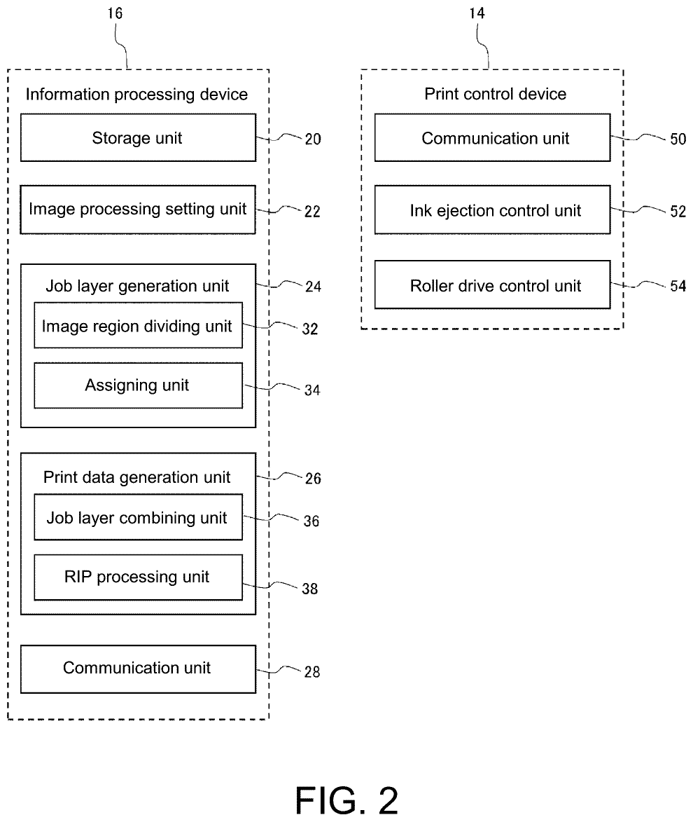

FIG. 2 is a functional block diagram related to the information processing device 16 and the print control device 14 of the present embodiment.

The information processing device 16 includes a storage unit 20, an image processing setting unit 22, a job layer generation unit 24, a print data generation unit 26, and a communication unit 28.

The storage unit 20 stores various data and programs such as image data to be printed on a recording medium.

The image processing setting unit 22 sets various types of processes for the image data. The image processing setting unit 22 may be general image editing software, and for example, various types of processes including color setting for image data are set.

In addition, the image processing setting unit 22 may set the foil transfer region in the image data according to, for example, an input operation by the user. In addition, the image processing setting unit 22 sets the texture process for the foil transfer region according to the input operation of the user. Details of the texture process will be described later.

The job layer generation unit 24 generates a job layer for each different process of printing an image of image data. For this purpose, the job layer generation unit 24 of the present embodiment includes an image region dividing unit 32 and an assigning unit 34.

In order to print an image of the image data by a plurality of different processes, the image region dividing unit 32 divides the image data into a plurality of image regions for each of the different processes.

The assigning unit 34 assigns an image region to a plurality of job layers for each different process. Note that the assigning unit 34 assigns an image region to the job layer so as not to overlap with an image region assigned to another job layer.

The print data generation unit 26 combines a plurality of job layers to generate print data that is data to be printed by the printing device 12. The print data generation unit 26 of the present embodiment is dedicated software operated by a user. The print data generation unit 26 performs raster image processor (RIP) process on the image data (job layer). The RIP process is a process of generating a raster image that designates an ejecting position for ejecting ink of a color corresponding to image data, and generates a raster image that designates an ejecting position for ejecting ink of the color by performing halftone process for a grayscale image corresponding to each color of color ink such as C, M, Y, and K.

For this purpose, the print data generation unit 26 of the present embodiment includes a job layer combining unit 36 and an RIP processing unit 38.

The job layer combining unit 36 combines a plurality of job layers to obtain print data.

The RIP processing unit 38 performs RIP processing on the job layer. In addition, the RIP processing unit 38 according to the present embodiment performs a mask process on a region other than the image region assigned to each job layer.

The communication unit 28 transmits and receives data to and from the print control device 14 and other information processing devices. Note that the communication unit 28 of the present embodiment transmits the print data to the print control device 14.

Next, functions of the print control device 14 will be described. As illustrated in FIG. 2, the print control device 14 includes a communication unit 50, an ink ejection control unit 52, and a roller drive control unit 54.

The communication unit 50 transmits and receives data to and from the information processing device 16, and receives print data from the information processing device 16.

The ink ejection control unit 52 controls the inkjet head to eject the color ink and the adhesive ink to the recording medium based on the print data.

The roller drive control unit 54 performs rotation control of various conveyance rollers for conveying the recording medium.

Note that when the printing device 12 includes a foil transfer device, the print control device 14 performs temperature control of the heater in order to dry the color ink ejected on the recording medium and thicken the adhesive ink.

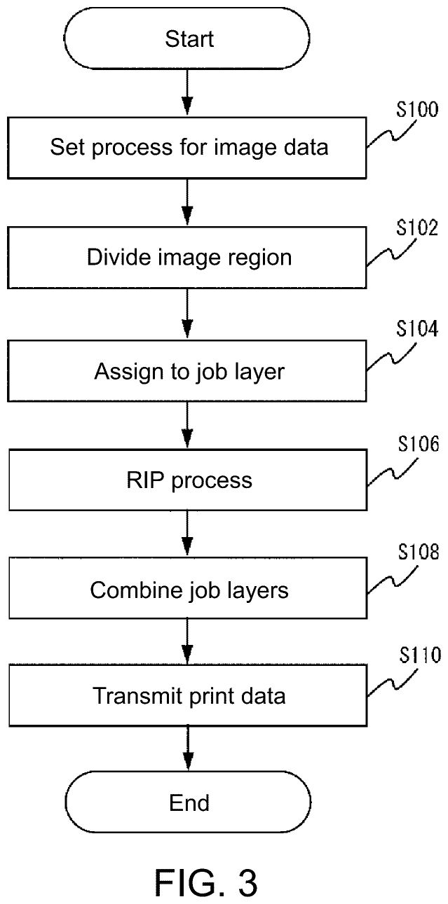

Next, a flow of print data generation process will be described with reference to FIG. 3.

First, in step S100, the image processing setting unit 22 sets the process for the image data.

In the next step S102, the image region dividing unit 32 divides the image data into a plurality of image regions for each different process.

In the next step S104, the assigning unit 34 assigns the image region divided for each different process to a plurality of job layers.

In the next step S106, the RIP processing unit 38 performs RIP process on a plurality of job layers. Note that in this RIP process, a mask process is performed on the job layer.

In the next step S108, the job layer combining unit 36 combines a plurality of job layers to generate print data.

In the next step S110, the print data is transmitted to the print control device 14 via the communication unit 28. The print control device 14 controls the printing device 12 to perform printing for each job layer indicated by the received print data.

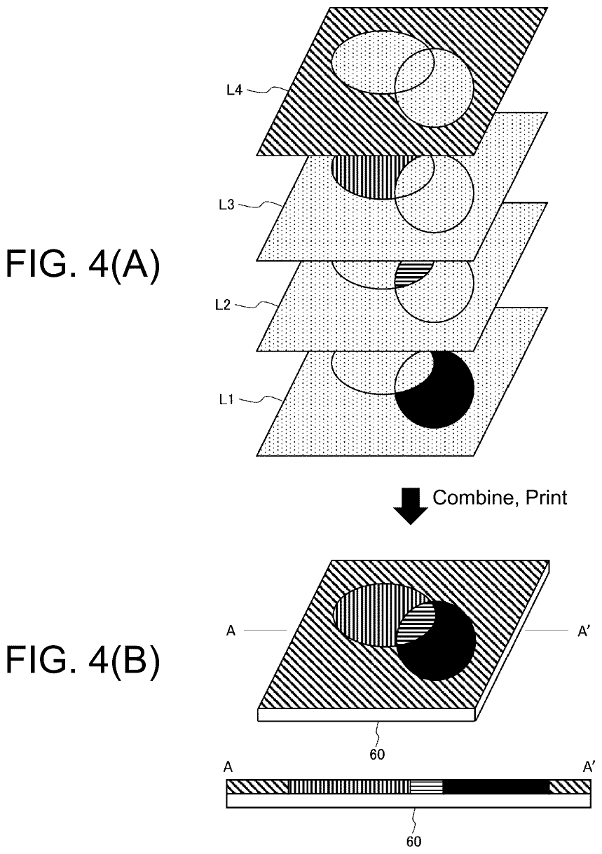

With reference to FIG. 4(A) and FIG. 4(B), division of an image region, assignment to a job layer, and mask process will be described. FIG. 4(A) is a schematic diagram illustrating a job layer generated by the information processing device 16. As an example, in the job layers L1 to L4, the image region is divided for each of the different colors of the original image data, and a job layer is assigned to each image region.

That is, a region filled in black in the job layer L1 is an image region assigned to the job layer L1. Furthermore, the hatched region of horizontal lines in the job layer L2 is an image region assigned to the job layer L2. The hatched region of vertical lines in the job layer L3 is an image region assigned to the job layer L3. The hatched region of oblique lines in the job layer L4 is an image region assigned to the job layer L4.

In addition, in the job layers L1 to L4, a region other than the assigned image regions is subjected to the mask process. A hatched region by a point is a masked region in the job layers L1 to L4. That is, in the job layer L1, a region other than the region filled in black is subjected to the mask process. In the job layer L2, a region other than the hatched region of horizontal lines is subjected to the mask process. In the job layer L3, a region other than the hatched region of vertical lines is subjected to the mask process. In the job layer L4, a region other than the hatched region of oblique lines is subjected to the mask process.

Then, the job layers L1 to L4 subjected to the mask process are combined to generate print data, and an image is printed on the recording medium 60 by the printing device 12 based on the print data. Note that the printing device 12 prints images on the recording medium 60 in the order of the job layer L1, the job layer L2, the job layer L3, and the job layer L4.

FIG. 4(B) is a schematic diagram illustrating a printing state on a product, that is, the recording medium 60 by printing using the job layers L1 to L4 of FIG. 4(A), and illustrates a top view and an enlarged cross-sectional view of a cross section taken along line A-A′ in the top view.

The printing device 12 performs printing on the recording medium 60 for each of the different colors based on the job layers L1 to L4 on which the mask process has been performed. Therefore, as illustrated in FIG. 4(B), printing is performed on the recording medium 60 without the colors overlapping each other. In this manner, by performing the mask process on each of the job layers L1 to L4, it is possible to more reliably prevent images subjected to different processes from overlapping on the recording medium.

Note that in the example of FIG. 4(A) and FIG. 4(B), image regions of different processes are assigned to the job layers L1 to L4, but the present disclosure is not limited thereto, and image regions of partially the same process may be assigned to different job layers.

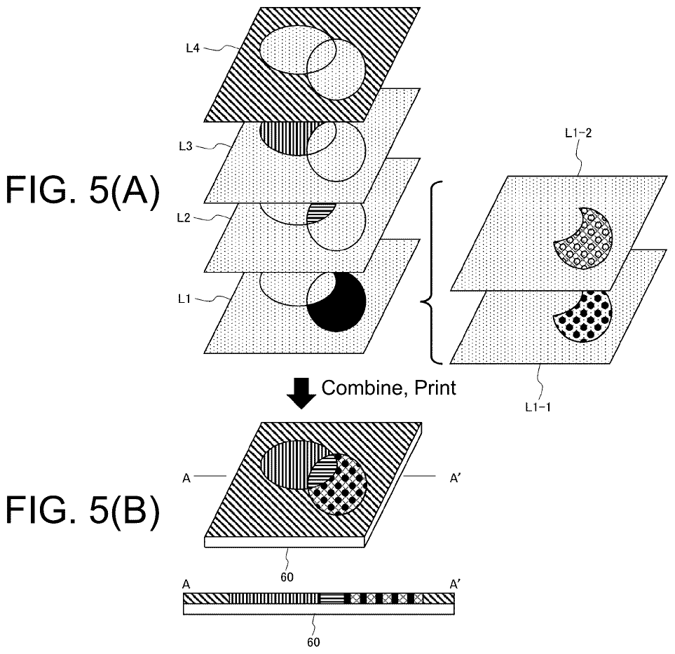

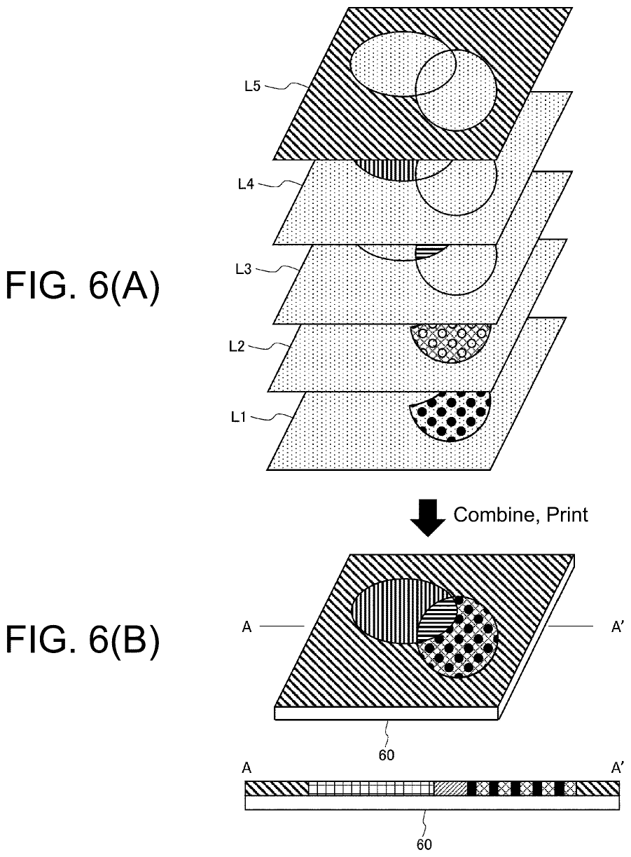

Next, a job layer when foil transfer printing is performed will be described with reference to FIGS. 5 and 6.

In the foil transfer printing, a defect such as cracking may occur in the foil transferred to the recording medium 60. This defect is caused by ejecting the adhesive ink onto the entire surface of a certain or more region to transfer the foil onto the entire surface. Therefore, in the printing device 12 of the present embodiment, the foil is transferred to the recording medium 60 in a pattern form by ejecting the adhesive ink to the foil transfer region in a predetermined pattern. The pattern of the present embodiment is, by way of an example, a dotted halftone dot. In addition to dotted halftone dots, star-shaped halftone dots may be used as a pattern, and not limited to halftone dots, other patterns (hereinafter referred to as “texture”) such as gradation using lines and halftone lines may be used to express various designs by foil transfer. Hereinafter, a process of ejecting the adhesive ink in a predetermined pattern to the foil transfer region is referred to as a texture process.

Furthermore, in the texture process of the present embodiment, a color (hereinafter referred to as “background color”) set in advance is printed by color ink to a gap where a halftone dot is not formed in the foil transfer region. When the background color is not printed in the foil transfer region, the color ink is not ejected to the gap between the halftone dots, and the surface color of the recording medium 60 remains. Therefore, by printing the background color in the foil transfer region, decorativeness of the image to be printed on the recording medium 60 is enhanced.

Thus, in the texture process of the present embodiment, process by a plurality of different materials such as the adhesive ink and the color ink is set for the foil transfer region. Note that setting of the texture and setting of the background color with respect to the foil transfer region are performed by the image processing setting unit 22 included in the information processing device 16.

As an example, in a case where the texture process is performed, the printing system 10 of the present embodiment performs a replacement process of replacing a predetermined job layer among a plurality of job layers with a plurality of job layers separately generated. Note that, in the replacement process, the user selects a job layer to be replaced, and replaces the selected job layer with a plurality of job layers separately generated. As a result, the user can set different processes for a desired job layer.

In the example of FIG. 5(A) and FIG. 5(B), a foil transfer region is assigned to the job layer L1. Then, as the replacement process, the job layer L1 is replaced with a job layer L1-1 and a job layer L1-2.

The job layers L1-1 and L1-2 both correspond to the foil transfer region assigned to the job layer L1. The job layers L1-1 and L1-2 are separately generated based on image data indicating the foil transfer region. Specifically, a halftone dot foil transfer region is assigned to the job layer L1-1. Note that, in the job layer L1-1, a region other than halftone dots is subjected to the mask process. That is, in the job layer L1-1, the mask process is also performed on the image region to be the background color. On the other hand, an image region to be a background color is assigned to the job layer L1-2. Note that, in the job layer L1-2, a region other than the background color is subjected to the mask process. That is, in the job layer L1-2, the mask process is also performed on the image region to be the halftone dot.

As illustrated in FIG. 5(B), the color ink and the adhesive ink can be printed on the recording medium 60 without overlapping by setting the foil transfer region by such replacement process.

Note that the job layer for performing the texture process is not generated by the replacement process, and for example, it may be set in advance to eject the adhesive ink with halftone dots (texture) with respect to the image data, and it may be set to eject a predetermined color ink to gaps of the halftone dots.

In this mode, as illustrated in FIG. 6(A), the halftone dot foil transfer region is assigned to the job layer L1. In addition, an image region to be a background color in the foil transfer region is assigned to the job layer L2. The job layers L3 to L5 are assigned with image regions in which a process of ejecting different color inks is performed.

As a result, as illustrated in FIG. 6(B), the color ink and the adhesive ink can be printed on the recording medium 60 without overlapping.

In addition, the assigning unit 34 of the present embodiment may assign an image region overlapping an image region assigned to another job layer to some of the job layers. As a result, the image formed on the recording medium 60 is raised, and an image with high decorativeness can be printed. Note that such printing is referred to as overlapping printing, and an image region to be overlapped is set by the image processing setting unit 22.

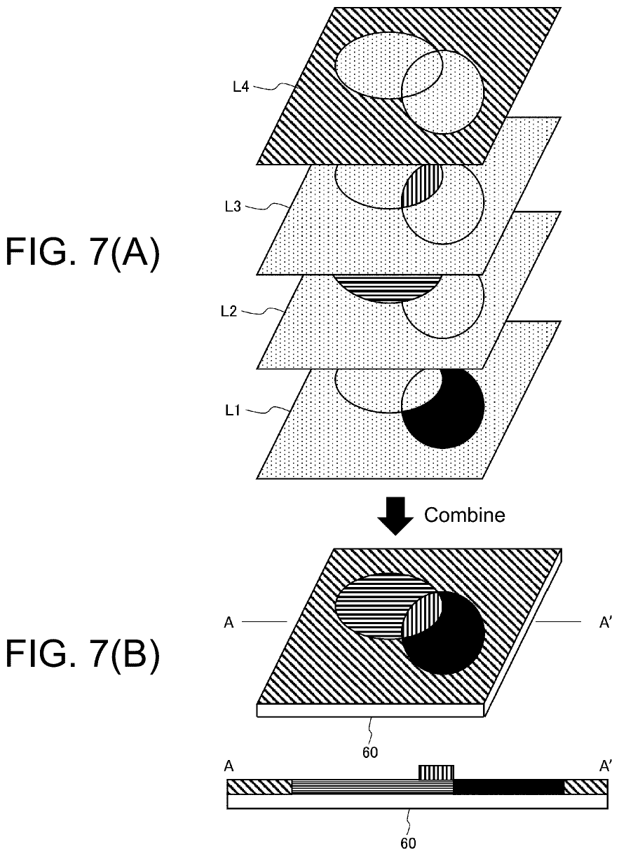

FIG. 7(A) and FIG. 7(B) are schematic diagrams illustrating overlapping printing, and FIG. 7(A) is a schematic diagram illustrating a job layer generated by the information processing device 16. As illustrated in FIG. 7(A), the image region of the job layer L2 and the image region of the job layer L3, which is an upper layer thereof, overlap each other. Then, as illustrated in the cross-sectional view of FIG. 7(B), since the image based on the job layer L3 is printed on the image printed based on the job layer L2, overlapping occurs in the height direction on the image formed on the recording medium 60.

As described above, the present disclosure has been described using the embodiment described above, but the technical scope of the present disclosure is not limited to the scope described in the above embodiment. Various changes or improvements can be added to the embodiment described above without departing from the scope of the disclosure, and a mode in which changes or improvements are added is also encompassed within the technical scope of the present disclosure.

In the above embodiment, a mode in which the printing device 12 is an inkjet printer has been described, but the present disclosure is not limited thereto, and the printing device 12 may be other printers such as a laser printer.

Furthermore, in the above embodiment, a mode in which the mask process is performed on each job layer has been described, but the present disclosure is not limited thereto, and a mode in which the mask process is not performed on the job layer may be adopted.

### Effects of the embodiment

(1) An information processing device 16 according to the present embodiment is an information processing device for performing printing based on image data on a recording medium 60 using a printing device 12, the information processing device including: an image region dividing unit 32 that divides image data into a plurality of image regions for each of a plurality of different processes in order to print an image of the image data by the plurality of different processes; an assigning unit 34 that assigns the image region to a plurality of job layers for each of the different processes; and a print data generation unit 26 that combines the plurality of job layers to generate print data, in which the assigning unit 34 assigns the image region to the job layer so as not to overlap with image regions of other job layers.

According to the present embodiment, a plurality of job layers are generated by dividing an image region for each of the different process for image data, and print data is generated by combining the plurality of job layers. The image region assigned to the job layer and the image region assigned to another job layer do not overlap each other. As a result, in this configuration, an image can be printed on the recording medium 60 without the image regions subjected to different processes overlapping each other.

(2) In the job layer of the present embodiment, mask process is performed on a region other than the assigned image region. According to the present embodiment, images subjected to different processes can be more reliably prevented from overlapping on the recording medium 60.

(3) The information processing device 16 according to the present embodiment replaces a predetermined job layer among a plurality of job layers with a plurality of job layers generated separately. According to this configuration, the user can set different processes for a desired job layer.

(4) The assigning unit 34 according to the present embodiment assigns an image region overlapping an image region assigned to another job layer to some of the job layers. According to the present embodiment, the image formed on the recording medium 60 is raised, and an image with high decorativeness can be printed.

1. An image processing device for performing printing based on image data on a recording medium using a printing device, the image processing device comprising:
an image region dividing means configured to divide the image data into a plurality of image regions for each of a plurality of different processes to print an image of the image data by the plurality of different processes;
an assigning means configured to assign the image region to a plurality of job layers for each of the different processes; and
a print data generation means configured to generate print data by combining the plurality of the job layers; wherein
the assigning means assigns the image region to the job layer so as not to overlap the image region of another job layer.

2. The image processing device according to claim 1, wherein mask process is performed on a region other than the assigned image region in the job layer.

3. The image processing device according to claim 1, wherein a predetermined job layer among the plurality of the job layers is replaced with the plurality of the job layers generated separately.

4. The image processing device according to claim 1, wherein the assigning means assigns the image region overlapping the image region assigned to another job layer to some of the job layers.

5. An image processing method for performing printing based on image data on a recording medium using a printing device, the image processing method comprising:
a first step of dividing the image data into a plurality of image regions for each of a plurality of different processes to print an image of the image data by the plurality of different processes;
a second step of assigning the image region to a plurality of job layers for each of the different processes; and
a third step of generating print data by combining a plurality of the job layers; wherein
the second step assigns the image region to the job layer so as not to overlap the image region of another job layer.

6. The image processing device according to claim 2, wherein a predetermined job layer among the plurality of the job layers is replaced with the plurality of the job layers generated separately.

7. The image processing device according to claim 2, wherein the assigning means assigns the image region overlapping the image region assigned to another job layer to some of the job layers.

8. The image processing device according to claim 3, wherein the assigning means assigns the image region overlapping the image region assigned to another job layer to some of the job layers.
